(19) United States
(12) Patent Application Publication
(10) Pub. No.: US 2018/0226062 A1
(43) Pub. Date: Aug. 9, 2018

(54) SNARE DRUM WITH WOODEN SHELL AND CARBON FIBER SHELL CAPS

(71) Applicant: BD Performing Arts, Concord, CA (US)

(72) Inventors: Allan Murray, Concord, CA (US); Scott Johnson, Concord, CA (US)

(21) Appl. No.: 15/943,615

(22) Filed: Apr. 2, 2018

Related U.S. Application Data
(63) Continuation of application No. 15/413,326, filed on Jan. 23, 2017, now Pat. No. 9,934,766.
(60) Provisional application No. 62/281,667, filed on Jan. 21, 2016.

(51) Int. Cl. G10D 13/02

(52) U.S. Cl. CPC G10D 13/025

(57) ABSTRACT

The present invention is directed to a snare drum made of a wooden shell having a top edge forming a top opening and a top carbon fiber shell cap attached to the top edge of the wooden shell for supporting a top batter head over the top opening. In some embodiments of the invention, the wooden shell of the snare drum also has a bottom edge forming a bottom opening and the snare drum includes a bottom carbon fiber shell cap attached to the bottom edge of the wooden shell for supporting a bottom batter head across the bottom opening.

### CROSS-REFERENCE TO RELATED APPLICATIONS

This application is a continuation of U.S. patent application Ser. No. 15/413,326, filed Jan. 23, 2017, which claims the benefit of U.S. Provisional Patent Application No. 62/281,667, filed Jan. 21, 2016.

### BACKGROUND

### Field of the Invention

The present invention relates to musical instruments and more particularly to an improved snare drum made of a wooden shell and having carbon fiber shell caps.

### Discussion of the Prior Art

Modern snare drums are generally made of a wooden shell and Kevlar or carbon fiber top and bottom batter heads. The wooden shell must be reinforced with an aluminum ring to support the tightening and tuning of the Kevlar or carbon fiber batter heads. This widely used snare drum configuration was introduced in the early 1990s to provide a crisper, higher pitched drum sound as compared to previously used snare drums with plastic batter heads.

A decided drawback of this new configuration was that the aluminum reinforcement ring added roughly 5 pounds of weight to the snare drum. As marching band drummers become more mobile and band tempos steadily increase from 132 beats per minute to well over 200 beats per minute, the added weight has caused increased discomfort and exacerbated health issues among drummers, including back, knee and hip injuries.

Attempts have been made to incorporate more carbon fiber material into the snare drum in order to reduce the overall weight increase caused in part by the aluminum reinforcement ring. For example, carbon fiber shells were introduced to replace the wooden shells. However, carbon fiber shells are both expensive and time-consuming to tool and mold, while providing only minimal weight reduction and, since carbon fiber shells are non-porous, sound quality is poor. Because of these limitations musicians, teachers and manufacturer's largely abandoned efforts to design a lighter weight snare drum for the marching band market, instead prioritizing the sound quality provided by Kevlar and carbon fiber batter heads and aluminum-reinforced wooden shells over desires to reduce the overall weight of the drum.

### SUMMARY OF THE INVENTION

The snare drum of the present invention is made of a wooden shell having a top edge forming a top opening and a top carbon fiber shell cap attached to the top edge of the wooden shell for supporting a top batter head over the top opening. In some embodiments of the invention, the snare drum also includes a bottom edge of the wooden shell forming a bottom opening and a bottom carbon fiber shell cap attached to the bottom edge of the wooden shell for supporting a bottom batter head over the bottom opening.

The wooden shell allows for a richer, more resonant drum sound when compared to a carbon fiber shell, and the carbon fiber shell caps replace the need for a heavy aluminum reinforcement ring, resulting in significant overall weight reduction.

Additionally, in the snare drum of the present invention, the wooden shell has a larger diameter than previous shells that needed to make room for an aluminum reinforcement ring. The larger diameter shell allows for increased air circulation inside the shell chamber. When the top batter head is struck, the increased air circulation provides a crisper, richer drum sound compared to prior art snare drums and the overall stress on the drummer's fingers, knuckles and wrists is reduced.

Thus, the present invention is directed to an improved snare drum for use in marching bands that provides the sound quality of a wooden shell and Kevlar or carbon fiber batter heads in a substantially lighter construction.

### BRIEF DESCRIPTION OF THE DRAWINGS

FIG. 1 is an upper perspective view of a snare drum according to the invention.

FIG. 2 is a lower perspective view thereof showing the snare assembly.

FIG. 3A is a side elevation view thereof showing the snare assembly in an upper position in which the snares are engaged with the bottom head.

FIG. 3B is a side elevation view similar to FIG. 3A but showing the snare assembly in a lower position in which the snares are disengaged from the bottom head.

FIGS. 4A and 4B are side elevation and top plan views, respectively, of the throw-off mechanism, mounting assemblies, snare frame and snares thereof.

FIG. 5 is an exploded view of the throw-off mechanism, mounting assemblies, snare frame and snares shown in FIGS. 4A and 4B.

FIG. 6A is a simplified upper perspective view showing the strainer mechanism installed in the shell of a snare drum according to the invention.

FIG. 6B is a simplified upper perspective view similar to FIG. 6A, but with parts of the strainer mechanism cut away to show the attachment plate openings in the sides of the shell.

FIG. 6C is a close-up view of a portion of FIG. 6A showing where one end of the strainer and strainer shaft are mounted to the shell.

FIG. 7A is a simplified upper perspective view similar to FIG. 6A showing the strainer mechanism installed in the shell of a snare drum from a different angle and also showing the throw-off handle on the outside of the shell.

FIG. 7B is a close-up view of a portion of FIG. 7A showing the throw-off handle.

FIG. 7C is a close-up view of a portion of FIG. 7A showing the throw off mechanism where attached to the inside of the shell opposite the handle.

FIG. 8 is an enlarged exploded upper perspective view of the inner attachment plate and fasteners.

FIG. 9A is an enlarged upper perspective view of the outer attachment plate.

FIG. 9B is an enlarged upper perspective view of the opposite side of the attachment plate shown in FIG. 9A.

FIG. 10 is an enlarged upper perspective view showing the relationship between the strainer, strainer shaft, inner and outer attachment plates, throw-off handle, and throw off end housings.

FIG. 11 is an upper perspective view of a snare drum according to the invention wherein the shell has been removed to show the interior workings of the drum.

FIG. 12 is a sectional view of the throw off mechanism showing elements thereof in engaged and disengaged configurations.

### DETAILED DESCRIPTION OF THE ILLUSTRATED EMBODIMENT

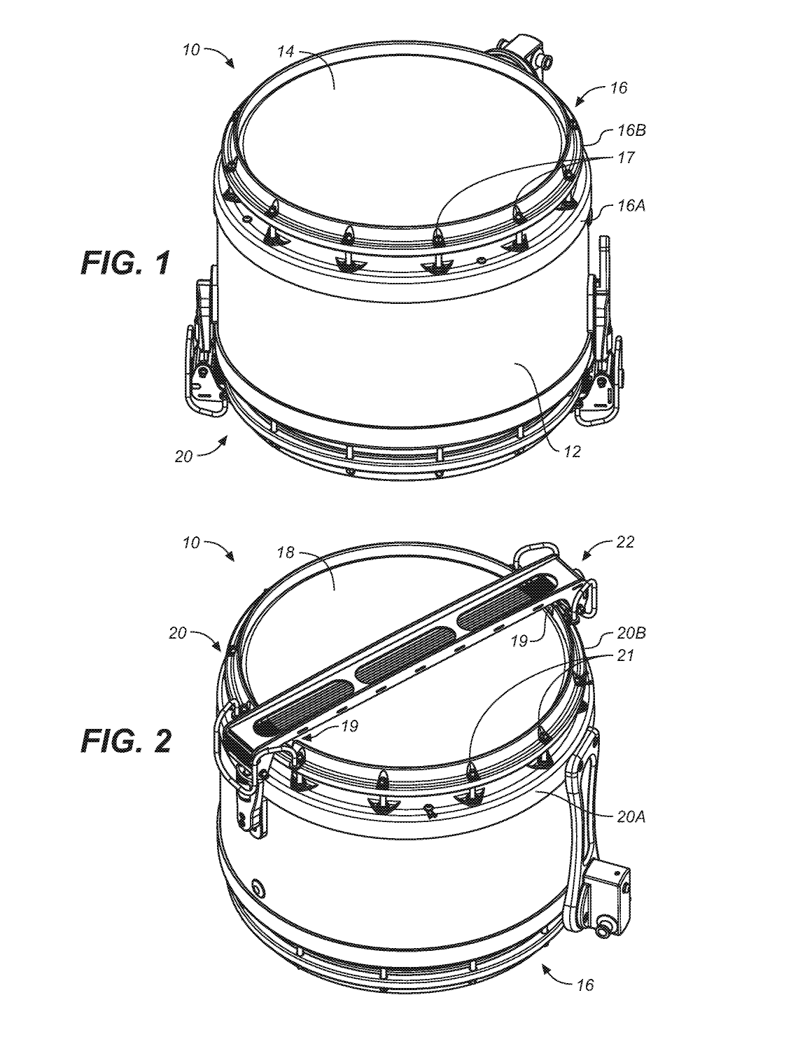

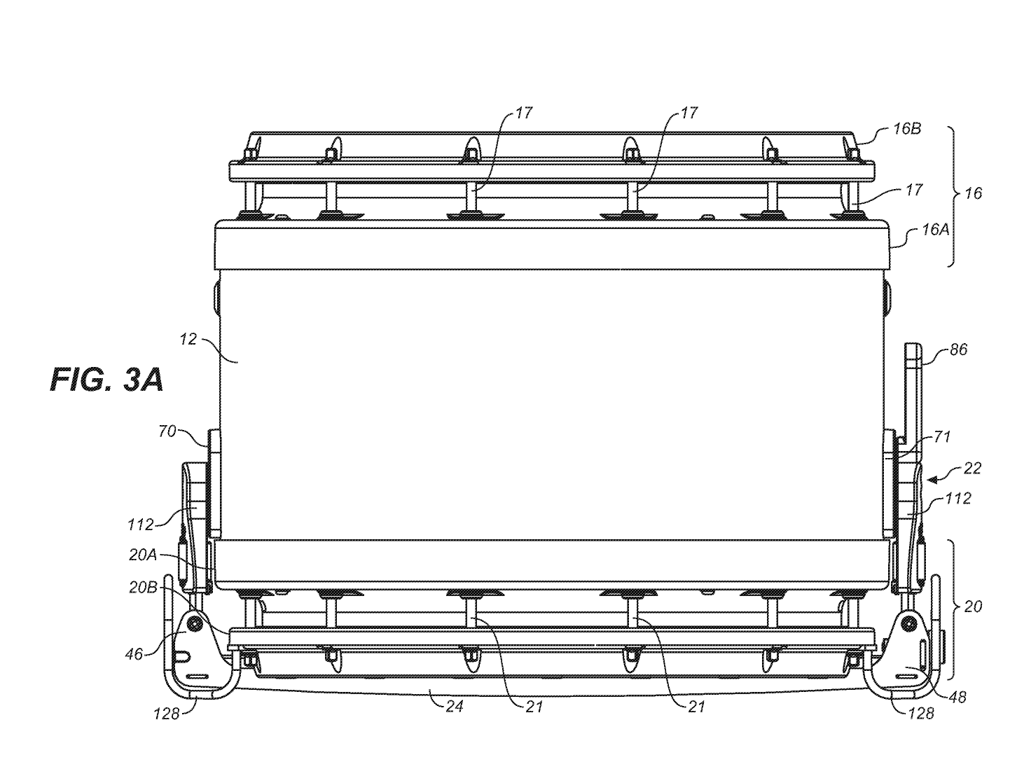

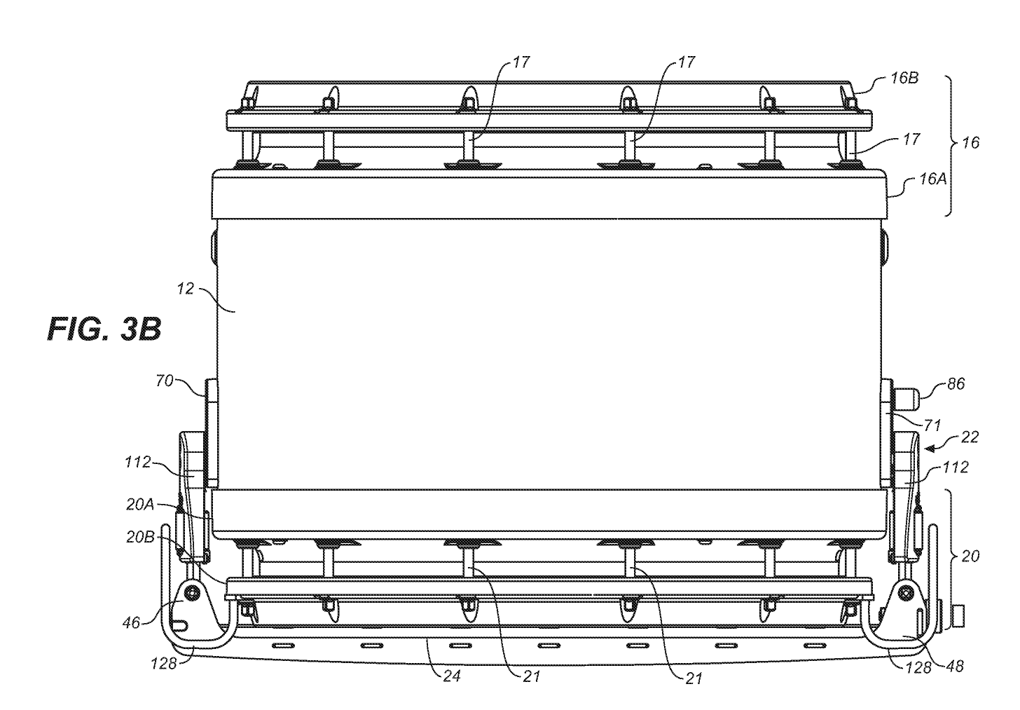

A snare drum according to the invention is referred to generally at numeral 10 in FIGS. 1 and 2. The snare drum 10 comprises a shell 12 and top head 14 held onto the shell by a top rim assembly 16. As seen in FIG. 2, the snare drum 10 also comprises a bottom head 18 held to the shell by a bottom rim assembly 20. FIGS. 2 and 3 show a snare assembly 22 attached to the bottom portion of the drum.

The top rim assembly 16 comprises a carbon-fiber shell cap 16A attached to the top of shell 12. In one embodiment of the snare drum the shell is constructed of laminated wood, particularly a 4-ply wood composite. Top head 14 is placed over the top edge of top shell cap 16A and is held thereon by top rim or hoop 16B. Top rim 16B is secured to top shell cap 16A with a plurality of tension rods 17. Similarly, the bottom rim assembly 20 comprises a carbon-fiber shell cap 20A attached to shell 12. Bottom head 18 is placed over the bottom edge of bottom shell cap 20A and is held thereon by bottom rim or hoop 20B. Bottom rim 20B is secured to bottom shell cap 20A with a plurality of tension rods 21 anchored in retention plates 23. Indents 19 on opposite sides of bottom hoop 20B accommodate snare assembly 22 so that the snares can engage bottom head 18 as discussed in greater detail below.

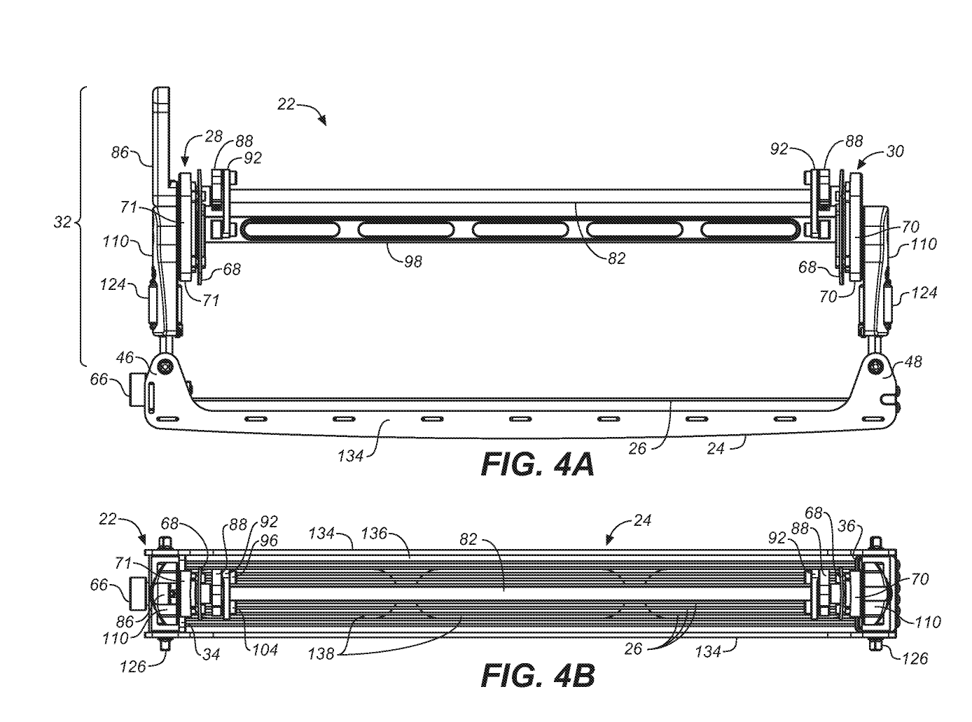

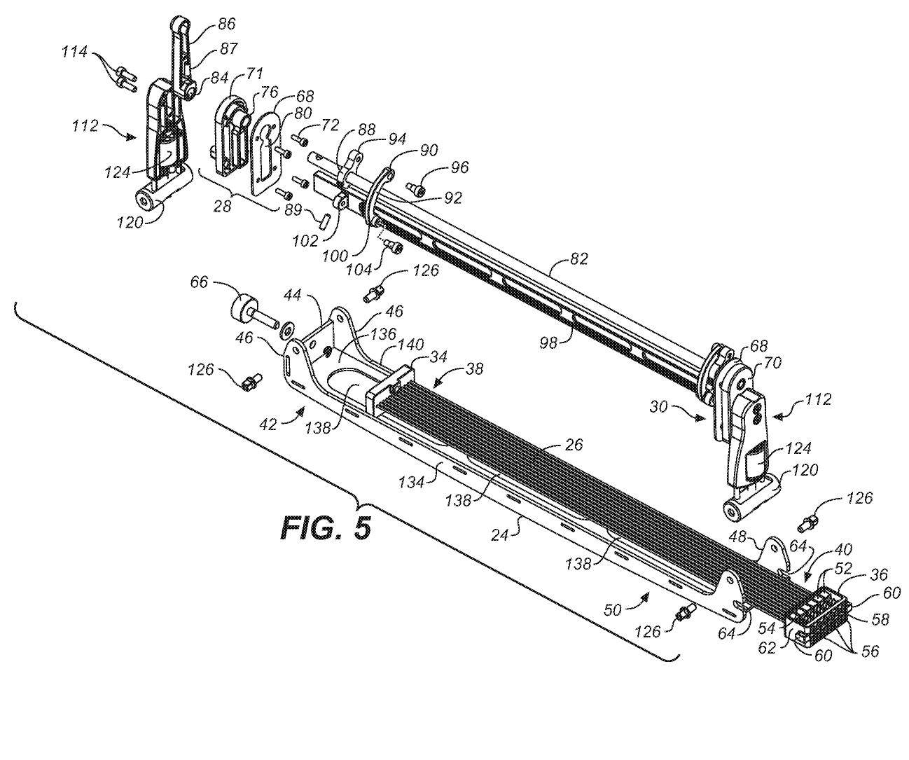

Referring next to FIGS. 4A and 4B, it can be seen that the snare assembly 22 includes a snare frame 24, snares 26, first and second opposed mounting assemblies 28, 30, and a throw-off mechanism 32. With additional reference to FIG. 5, it is seen that the snares 26 are suspended between retention block 34 and retention frame 36 on opposite ends of the frame. The first end 38 of each snare 26 is attached to retention block 34, and the second end 40 thereof is attached to retention frame 36.

On a first end 42 of the snare frame 24 a retention plate 44 extends between a pair of upwardly extending flanges 46. A pair of spaced apart upstanding mounting ears 48 is provided on the second end 50 of the snare frame.

The second ends 40 of the snare wires 26 are each secured to individual adjustment blocks 52 disposed on the inside wall 54 of retention frame 36. Adjustment screws 56 are inserted through the outside wall 58 of retention frame 36 and threadedly engage adjustment blocks 52, such that tightening or loosening adjustment screws 56 increases or decreases tension on individual snares 26.

Opposing retention stops 60 extending outwardly from each of the side walls 62 of retention frame 36 are sized to slide snugly into retention slots 64 located on the outer edges of each of mounting ear 48. Retention frame 36 can thus be secured to mounting ears 48 by sliding stops 60 into retention slots 64 when the snares 26 are moved toward the first end 42 of the snare frame 24. The retention block 34 is secured to the retention plate 44 between flanges 46 by fastener 66 which enables increasing or decreasing tension simultaneously on all of the snares 26 by tightening or loosening fastener 66.

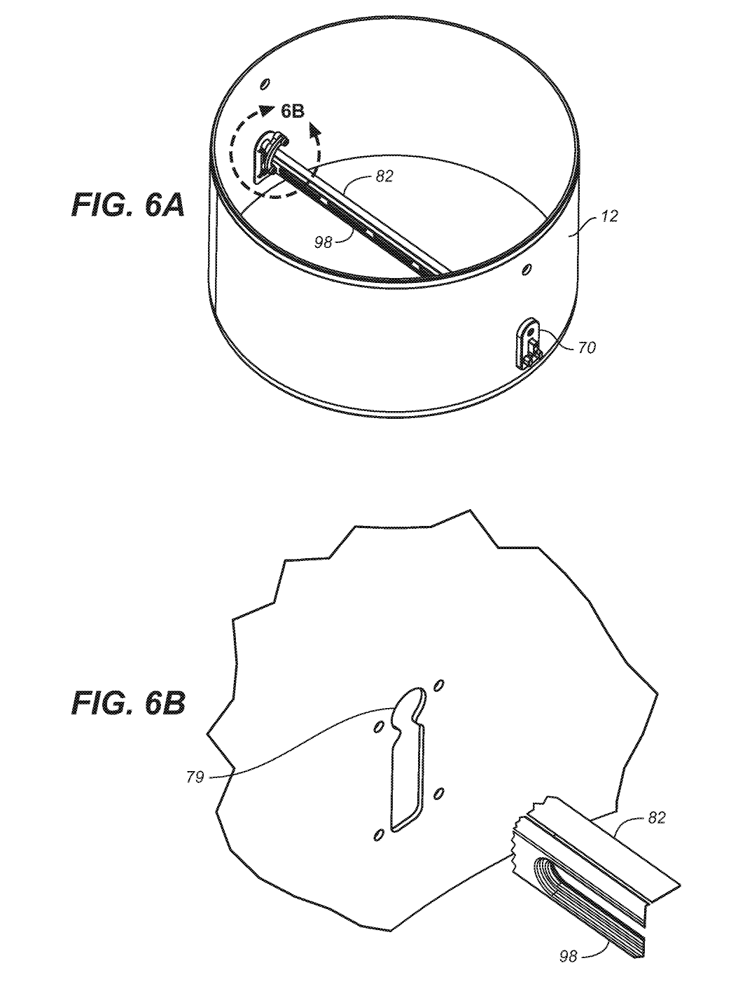

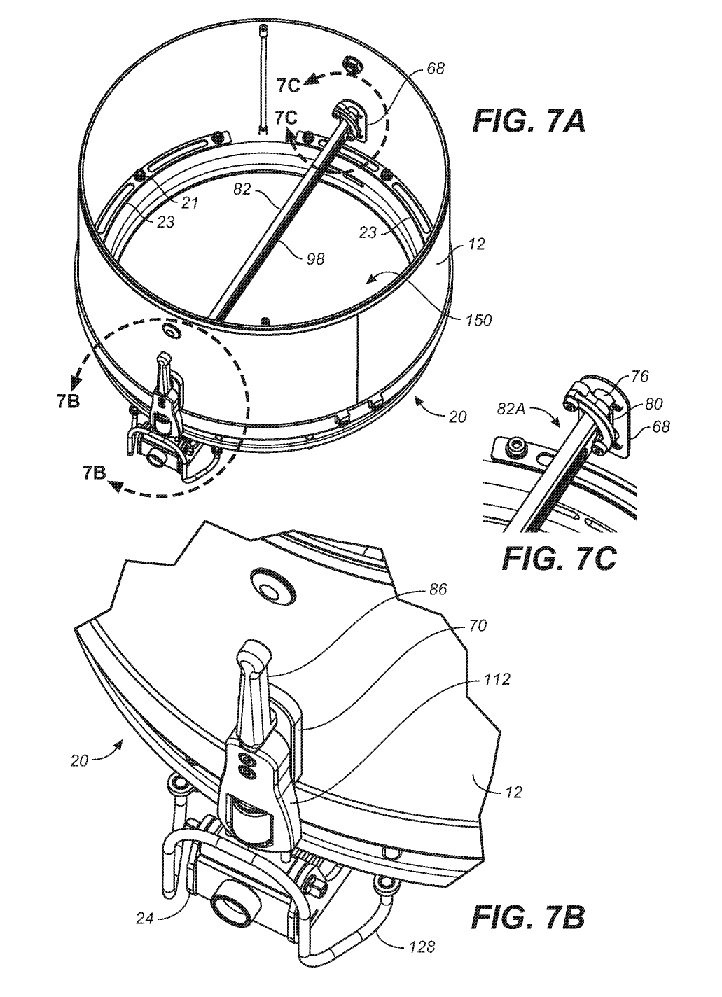

With continuing reference to FIG. 5, each mounting assembly 28, 30 comprises an inner attachment plate 68 and an outer attachment plate 70, 71. With reference to FIGS. 6A, 6B, 7A, 8 and 9A, it is seen that inner attachment plate 68 is positioned on the inside of shell 12 and secures outer attachment plate 70 to the outside of shell 12 with fasteners 72. A rectangular keeper channel 74 and a bushing 76 extend inwardly from the main body 78 of the outer attachment plate 70 through attachment plate opening 79 in shell 12 and are received in keyhole 80 in inner attachment plate 68.

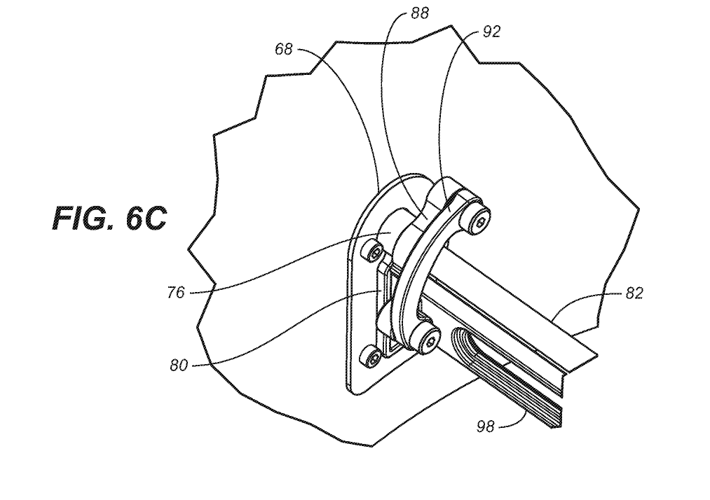

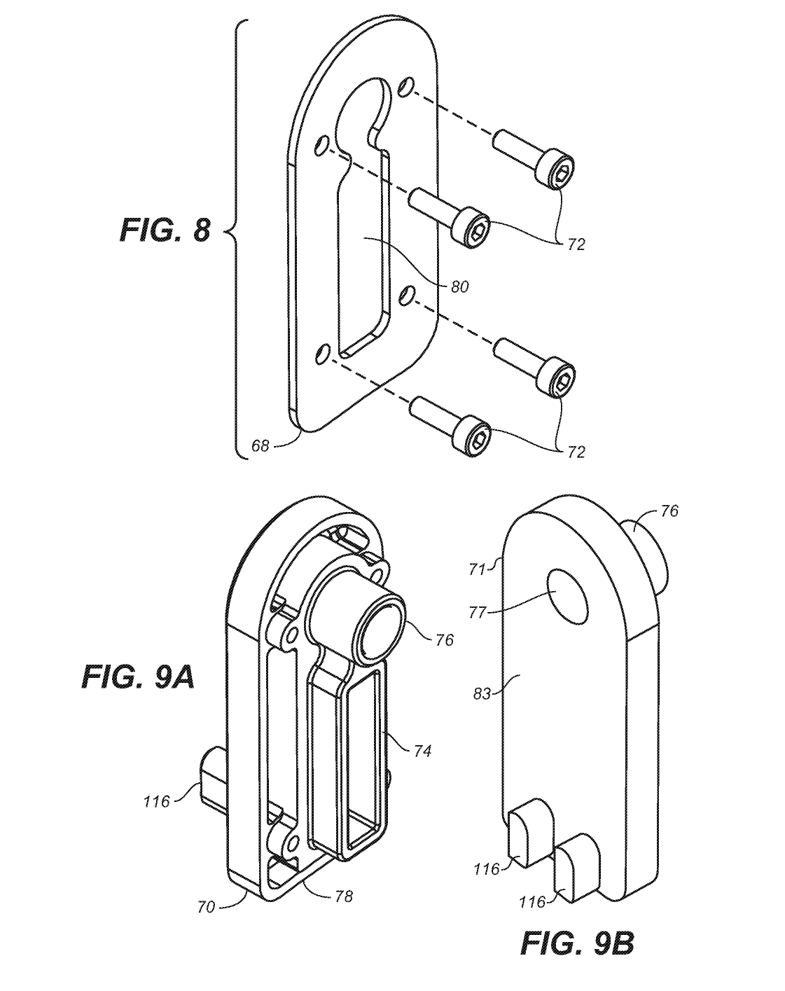

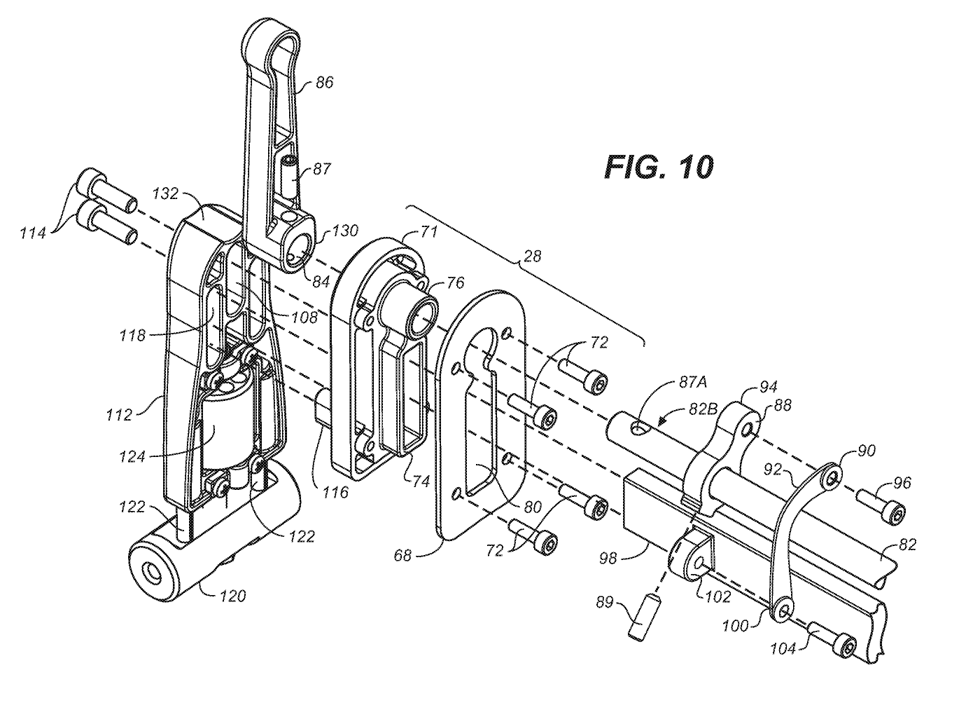

As can best be understood with reference to FIGS. 5 and 7C, one end 82A of strainer shaft 82 passes through keyhole 80 in the inner attachment plate 68 and is rotatably received in the bushing 76 of the outer attachment plate 70 of mounting assembly 30. Similarly, with reference to FIGS. 5, 6A, 6B and 10, the other end 82B of strainer shaft 82 passes through keyhole 80 in the inner attachment plate 68 and is rotatably received in the bushing 76 of the outer attachment plate 71 of the other mounting assembly 28. Outer attachment plate 71 is identical to outer attachment plate 70 except that bore 77 formed by bushing 76 opens in outer wall 83 of plate 71 as seen in FIG. 9B. This enables shaft end 82B to extend through bushing 76 into aperture 84 of throw-off handle 86 in which it is secured by tightening fastener 87 in hole 87A. Primary links 88 are attached to strainer shaft 82 by fastener 89 so that rotation of shaft 82 causes links 88 to swivel. The upper ends 90 of secondary links 92 are pivotally attached to extended free ends 94 of primary links 88 by pivot pins 96.

Each end of strainer bar 98 is captured in the keeper channel 74 of the outer attachment plates 70, 71 such that any axial movement is restrained. However, the vertical dimension of keeper channels 74 is greater than the height of strainer bar 98 so that the latter is freely moveable vertically in keeper channels 74. The lower ends 100 of secondary links 92 are pivotally attached to pivot bosses 102 fixed to the sides of strainer bar 98 by pivot pins 104.

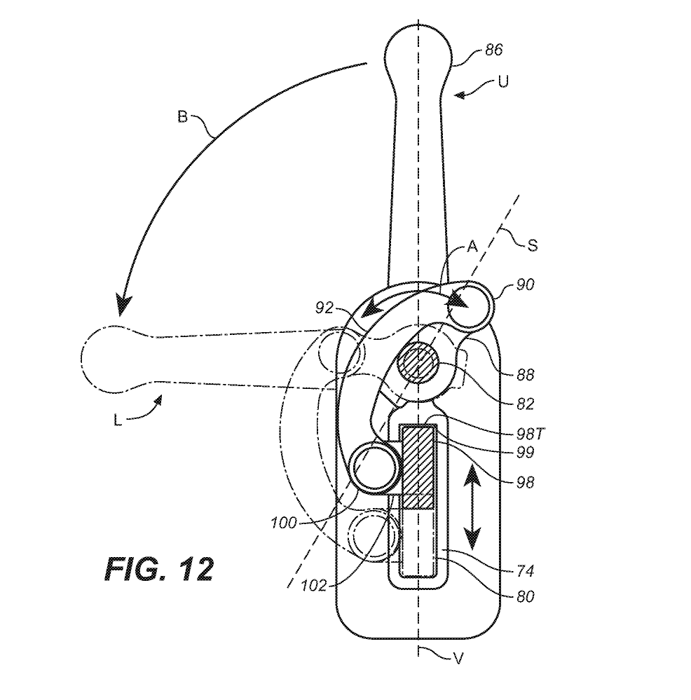

With reference now to FIG. 12, it is seen that rotation of shaft 82 by manipulation of handle 86 causes primary links 88 to swivel which causes the upper ends 90 of secondary links 92 to swivel through an arc A the vertical component of which causes the lower ends 100 thereof, and hence the strainer 98, to move vertically. Since the primary links 88 are attached to opposite ends of the strainer shaft 82, strainer bar 98 is maintained in parallel relation to lower head 18 throughout the range of such vertical movement.

Referring now to FIGS. 5, 9B and 10, it is seen that throw off end housings 112 abut the outer walls 83 of each of the outer attachment plates 70, 71. Each end of strainer bar 98 extends through outer attachment plate 70 into inwardly facing rectangular retaining recess 108 in end housing 112 and is affixed therein by fasteners 114. Dual studs 116 extending outwardly from the outer walls 83 of each outer attachment plates 70, 71 are slidingly received in guide slots 118. A barrel nut 120 is connected to the hood 110 of end housings 112 by vertical connection rods 122. The distance which connection rods 122 extend below end housing 112 can be finely adjusted by manipulating adjustment knob 124. Barrel nuts 120 are interposed between flanges 46 on the first end 42 and between mounting ears 48 on the second end 50 of the snare frame 24 and are secured thereto by fasteners 126. The basal portion 130 of handle 86 has a convex surface which mates with the concave curvature of the top 132 of end housing 112.

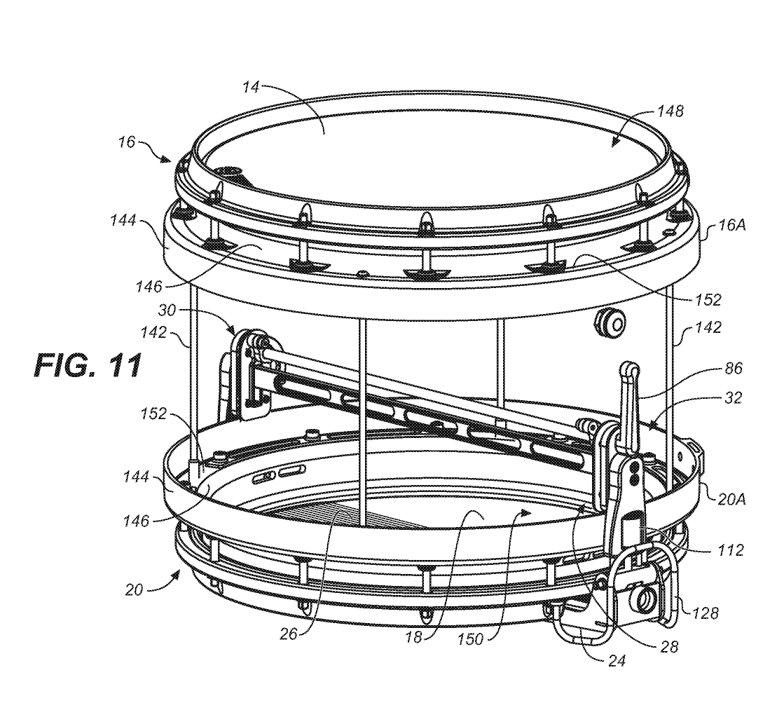

In FIG. 11, the relationship of snares 26, snare frame 24, mounting assemblies 28, 30 and throw-off mechanism can be seen in relation to the top head 14 and top rim assembly 16 and the bottom head 18 and bottom rim assembly 20. Stands 128 attached to bottom rim assembly 20 allow the snare drum 10 to be placed on a support surface with the snare frame 24 slightly elevated.

In another aspect of the invention, it is seen in FIG. 11 that the shell caps 16A, 20A are connected by internal posts 142. With additional reference to FIGS. 1-3B, it is seen that this enables the diameter of the shell 12 to be greater than the diameter of the top and bottom drum heads 14, 18 since the mechanisms for retaining the shell between the top and bottom rim assemblies 16, 20 are disposed within the interior of the shell as opposed to prior art tension rod lugs which are mounted on the outer surface of the shell. Each shell cap includes a shell band 144 which wraps around the upper or lower edge of the shell, a head band 146 which forms the top and bottom cap openings 148, 150 for the top and bottom drum heads 14, 18, and a radially extending tension rod plate 152 extending between and connecting the shell band and head band. Connecting rods 142 extend between and connect the tension rod plates 152 of the top and bottom shell caps 16A, 20A. Since the shell bands 144 have a diameter larger than the diameter of the head bands 146, the diameter of the shell itself can be larger than the diameter of the head bands. Thus, in the illustrated embodiment, the shell has a larger diameter than the top and bottom heads 14, 18 which allows more air to be moved through the drum for a unique percussive effect.

As seen in FIGS. 3A, 3B and 12, the snares 26 move vertically between an upper position shown in FIG. 3A, in which they are in direct contact with bottom head 18, and a lower position shown in FIG. 3B, in which they are spaced below bottom head 18, by rotating throw-off handle 86 between an upright position U and a lower position L disposed at an angle of approximately 90° to the upright position as indicated in FIG. 12 by arrow A. Since links 88, 92 are positioned at each end of shaft 82 and strainer bar 98 and work in tandem, strainer bar 98, strainer frame 24 and snares 26 are maintained in parallel disposition to bottom head 18 during such vertical movement.

In the upright position, the free ends 94 of primary links 88 and the upper ends 90 of secondary links 92 are positioned at a slight angle beyond the top of arc A through which they travel during movement between the upper and lower positions U, L. Further rotation of links 88, 92 is prevented by engagement of secondary link 92 with shaft 82 as shown. It will be understood that upward movement of strainer bar 98 is prevented by contact between its top surface 98T and the upper walls 99 of keeper channels 74. This occurs when the free ends 94 of primary links 88 and the upper ends 90 of secondary links 92 are at a slight angle to either side of the top of arc A, such that urging the links over strainer bar 82 and across a strainer bar plane S that is coincident with strainer bar 82 places secondary links 92 under longitudinal stress thereby urging the upper and lower ends 90, 100 thereof together and locking strainer 86 in the upper position. Conversely, the strainer bar 98 can be released from the upper position U to the lowered position L by application of sufficient force on the throw-off handle 86 to move the free ends of 94 links 88 and the upper ends 90 of secondary links 92 back through top arc A and past strainer bar plane S.

Snare frame 24 includes two spaced apart parallel rails 134 extending between flanges 46 and mounting ears 48. A bottom plate 136 extends between rails 134 and includes a plurality of relatively large apertures 138. In the engaged configuration, the top edges 140 of the rails are brought into close adjacency to the bottom head 18 of the snare drum so that the rails 134, bottom plate 136 and apertures 138 form an amplification chamber for amplifying the sounds made by the snares 26 and directing them downwardly through the apertures. The direction and amplification effect is particularly pronounced when the sounds are emitted at soft dynamic levels.

The snare drum 10 has several unique advantages. First, sandwiching a laminated wood shell between carbon-fiber bearing rings significantly reduces the weight of the drum by eliminating the heavy aluminum bearing edges and lug tubes on the sides of the shell used in the prior art. Additionally, the snares 26 can be raised against and lowered away from the bottom head 18 while being maintained in parallel alignment therewith throughout the range of movement between engaged and disengaged positions. This permits the snares to be tuned while disengaged from the bottom head and then to be engaged with the bottom head in tune without losing tension, so that retuning after reengagement of the snare assembly is no longer required.

In addition, the adjustment knobs 124 in each throw off end housing 112 allow fine adjustments of how far the connection rods 122 are extended below the end housing's hood 110 in order to set the distance or degree of tension between the shares 26 and the bottom head 18. Adjustment screws 66 and 56 permit collective and individual adjustment to the tension of the snares 26. The amplification chamber collects, amplifies and directs the sounds produced by the snares 26 instead of allowing them to disperse in all directions.

There have thus been described and illustrated certain embodiments of a snare drum according to the invention. Although the present invention has been described and illustrated in detail, it should be clearly understood that the disclosure is illustrative only and is not to be taken as limiting, the spirit and scope of the invention being limited only by the terms of the appended claims and their legal equivalents.

I claim:

1. A snare drum comprising:
a shell having a top edge forming a top opening, the shell comprising wood, and
a top shell cap attached to the top edge of the shell for supporting a top batter head over the top opening, the top shell cap comprising carbon fiber.

2. The snare drum of claim 1 further comprising:
the shell having a bottom edge forming a bottom opening; and
a bottom shell cap attached to the bottom edge of the shell for supporting a bottom batter head across the bottom opening, the bottom shell cap comprising carbon fiber.

3. The snare drum of claim 1, the shell comprising a laminated wood.

4. The snare drum of claim 3, the shell comprising a 4-ply wood composite.

5. The snare drum of claim 1 further comprising:
a top rim for securing a top batter head to the top shell cap, and
one or more top tension rods,
the top rim secured to the top shell cap by the one or more top tension rods.

6. The snare drum of claim 5 further comprising:
a bottom rim for securing a bottom batter head to the bottom shell cap, and
one or more bottom tension rods, and
one or more bottom retention plates disposed within the shell, the bottom rim secured to the bottom shell cap by the one or more bottom tension rods, and the one or more bottom tension rods anchored to the one or more bottom retention plates disposed within the shell.

7. The snare drum of claim 2 further comprising:
a plurality of internal posts disposed within the shell, the internal posts extending between and connecting the top and bottom shell caps.

8. The snare drum of claim 7:
the top shell cap further comprising:
a top shell band wrapped around the upper edge of the shell,
a top head band forming a top cap opening, and
a radially extending top tension rod plate extending between and connecting the top shell band and the top head band; and
the bottom shell cap further comprising:
a bottom shell band wrapped around the bottom edge of the shell,
a bottom head band forming a bottom cap opening, and
a radially extending bottom tension rod plate extending between and connecting the bottom shell band and the bottom head band.

9. The snare drum of claim 8:
the internal posts extending between and connecting the top tension rod plate and the bottom tension rod plate.

10. The snare drum of claim 9:
the top and bottom shell bands having the same diameter, the diameter of the top and bottom shell bands being larger than the diameter of the top and bottom head bands.

11. The snare drum of claim 10:
the shell having a larger diameter than the diameter of the top and bottom head bands.
